(19) United States
(12) Patent Application Publication
(10) Pub. No.: US 2016/0047205 A1
(43) Pub. Date: Feb. 18, 2016

(54) ELECTRIC ACTUATOR

(71) Applicant: COREteQ Systems Ltd., Bagshot (GB)

(72) Inventor: Philip Head, Virginia Water (GB)

(73) Assignee: COREteQ Systems Ltd., Bagshot (GB)

(21) Appl. No.: 14/834,660

(22) Filed: Aug. 25, 2015

Related U.S. Application Data
(63) Continuation of application No. PCT/EP2014/074788, filed on Nov. 17, 2014.

(30) Foreign Application Priority Data
Nov. 15, 2013 (GB) 1320242.9

(51) Int. Cl. E21B 41/00; E21B 43/12; F16H 1/36

(52) U.S. Cl. CPC E21B 41/00; F16H 1/36; E21B 43/128

(57) ABSTRACT

A motor transmission and gearbox are disclosed for downhole use, which include a first motor driving a first input shaft, a second motor driving a second input shaft, and a gearbox comprising at least a ring gear, a sun gear, and a planetary gear and planetary carrier. The first input shaft driving either the ring gear, the sun gear or the planetary gear and/or planetary carrier, the second input shaft driving one of the gears not driven by the first input shaft, and the remaining gear driving the output shaft.

### REFERENCE TO RELATED APPLICATIONS

This application is a continuation of, and claims priority to and the benefit of, International Application No. PCT/E P2014/074788, filed Nov. 17, 2014 and entitled “Electric Actuator”, and this application claims priority to and the benefit of U.K. Patent Application No. GB 1320242.9, filed Nov. 15, 2013, the entirety of which applications are hereby incorporated by reference.

This invention relates to an electric powered actuator, and more particularly to such motors for downhole use in oil wells, and most particularly to such motors operating sucker rod pumps, or push-pull tractors, or actuators to open and close sleeves.

It has long been recognised that production of oil by means of sucker rod pumps driven by surface mounted pump jack is very inefficient. Not only are the pumps and the rods connecting the downhole pump to the pumping jack very expensive, but they also suffer from several technical problems.

One of the major problems is that, since most wells are not “straight”, the sucker rod usually rubs against the tubing in a number of places in the well This problem is even more severe in wells that are intentionally directionally drilled and whose deviation from perfect straightness can be significant. Not only does this wear the sucker rod and the tubing, necessitating the costly replacement of both, but the friction between the sucker rod and the tubing wastes energy and requires more powerful motors to be used to operate the pump jack.

Other problems associated with pump jacks, is leaking of wellbore fluids between the polished rod and the stuffing box, representing an environmental hazard. The pump jack itself is also an eyesore and permission for its use in environmentally attractive areas or urban areas can be difficult.

It is an object of the present invention to provide a robust and controllable gearbox particularly suitable for downhole applications.

According to the present invention there is provided a motor transmission and gearbox for downhole use, comprising, a first motor driving a first input shaft, a second motor driving a second input shaft, a gearbox comprising at least, a ring gear, a sun gear, and, a planetary gear and planetary carrier, the first input shaft driving either the ring gear, the sun gear or the planetary gear and/or planetary carrier, the second input shaft driving one of the gears not driven by the first input shaft, the remaining gear driving the output shaft.

The output can be used to supply long stroke actuator movements inside the well at the pump using an electrically powered ball screw. The motors can be run continuously at different speeds to achieve upward and downward movement of the ball screw. The ball screw can then be employed to operate various devices, such as a rod lift pump, a push me pull me traction device, or an actuator to open and close sliding sleeves.

The system may be mounted at surface to directly replace a pump jack with a device with a significantly smaller foot print.

The epicyclic transmission may be driven by the two electric motors rotating in different directions and speeds to turn an output shaft either clock wise or anti clock wise without stopping either motor, and the change in direction of rotation can be achieved over a selected time period, or to any rate of deceleration and acceleration profile.

The motors can be set to maximum rotation speed before turning the output shaft.

The motors and gearbox, and the tool it is being used to operate, such as a downhole sucker rod pump in which a downhole electrically powered reciprocating electric actuator, may be powered by an umbilical from surface.

Preferably the reciprocating action is achieved by two electric motors rotating in the opposite direction, coupled via a epicyclical gearbox which in turn drives a ball screw. The speed of the motors may be adjusted to enable the ball screw to traverse either upward or downward without the electric motors having to be turned off.

By way of example the following figures will be used to describe embodiments of the invention.

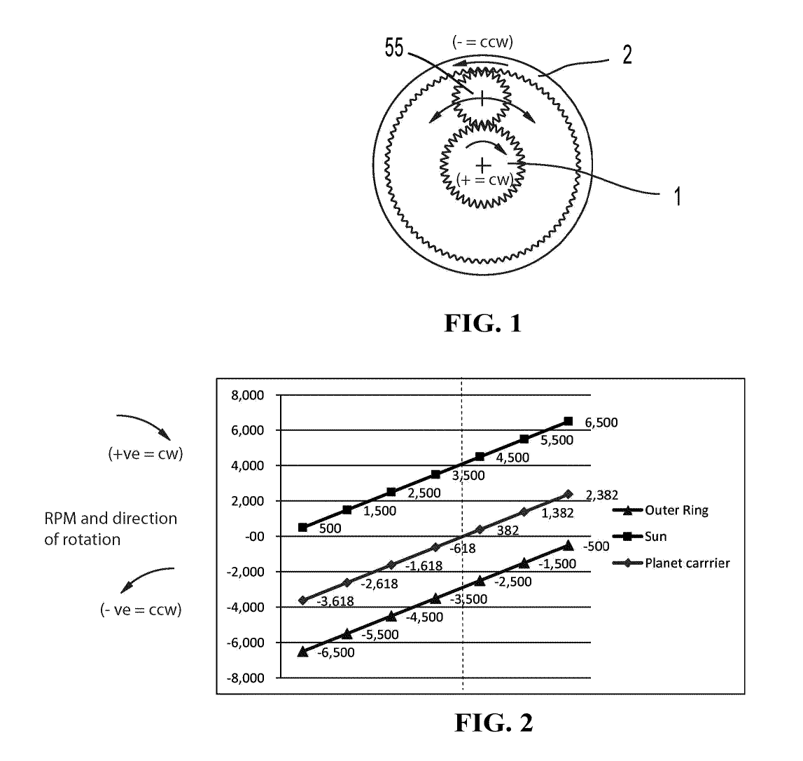

FIG. 1 is an end view of a epicyclic gear box

FIG. 2 is a graph showing the rotational speed of the sun and outer ring and the resulting rotational speed and direction of rotation of the planet carrier.

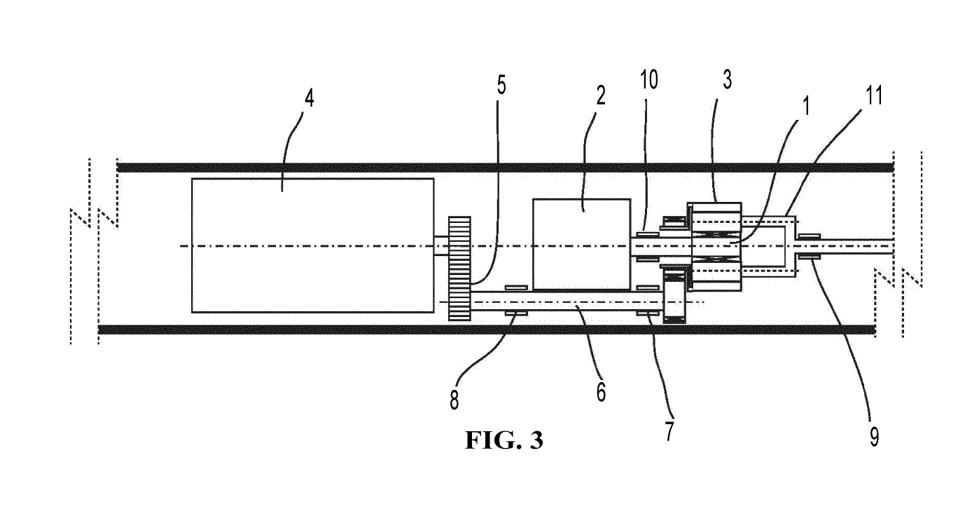

FIG. 3 is a section side view through housing containing two electric motors and an epicyclic gear box.

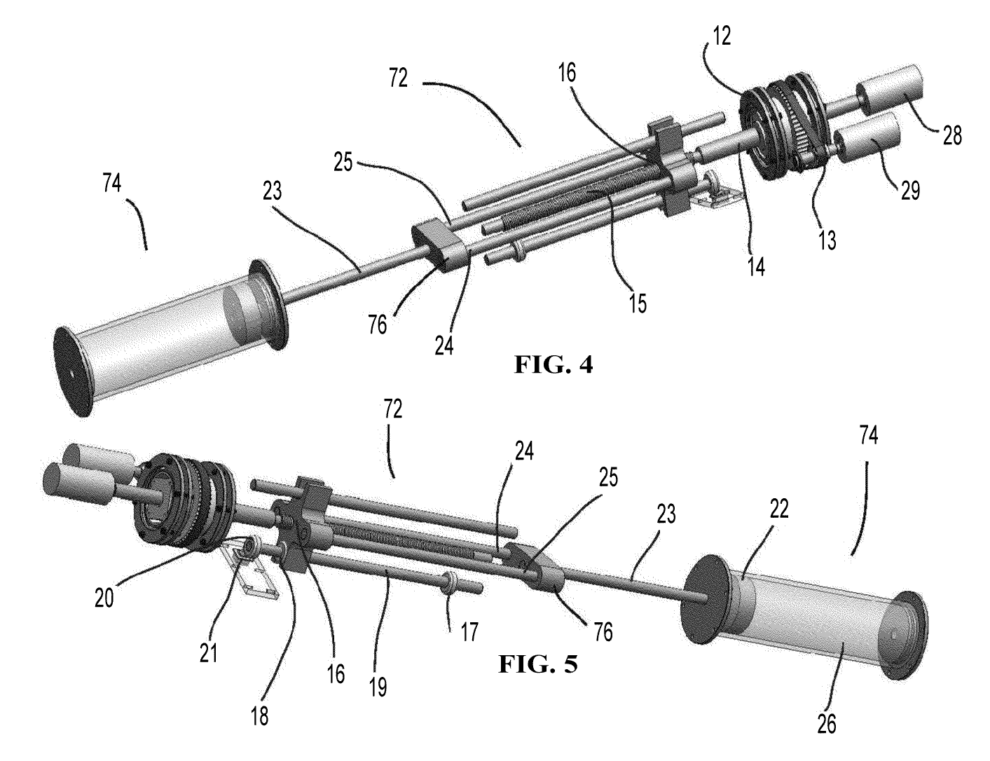

FIG. 4 is a isometric view of the two electric motors, epicyclic gearbox, with output to a ball screw, in turn attached to a rod lift pump (housing removed for clarity)

FIG. 5 is a isometric view of the same components shown in FIG. 5.

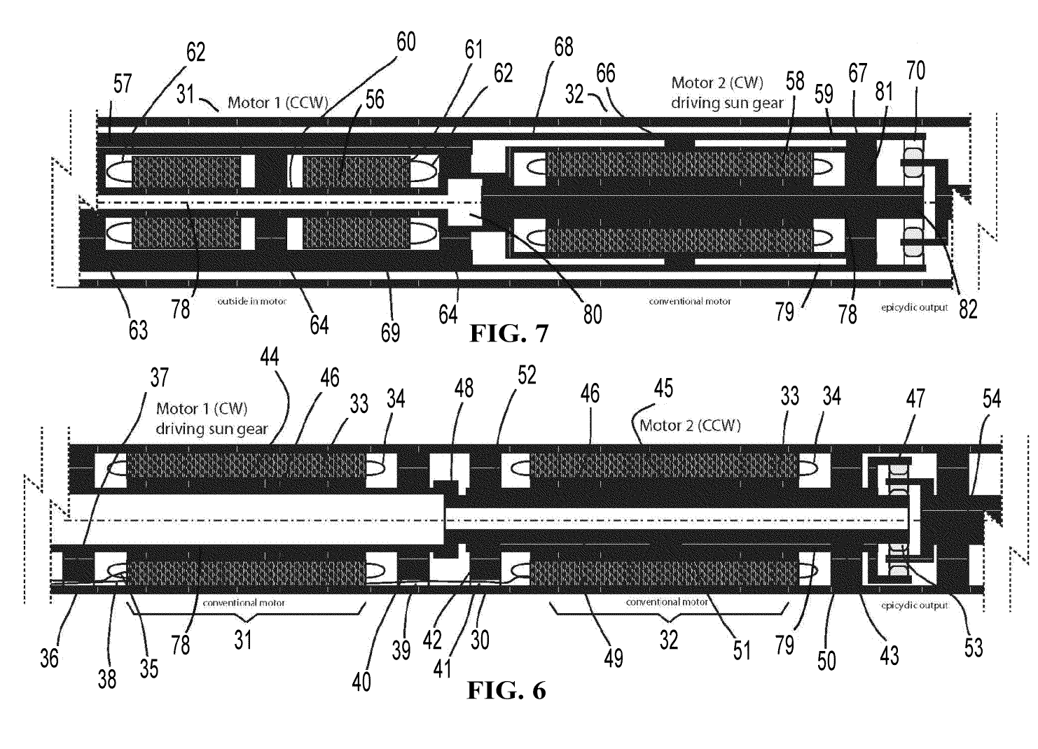

FIG. 6 is a section side view of two different types of electric motor mounted concentrically, coupled to a epicyclic gear box.

FIG. 7. is a section side view of two similar types of electric motor mounted concentrically, coupled to a epicyclic gear box.

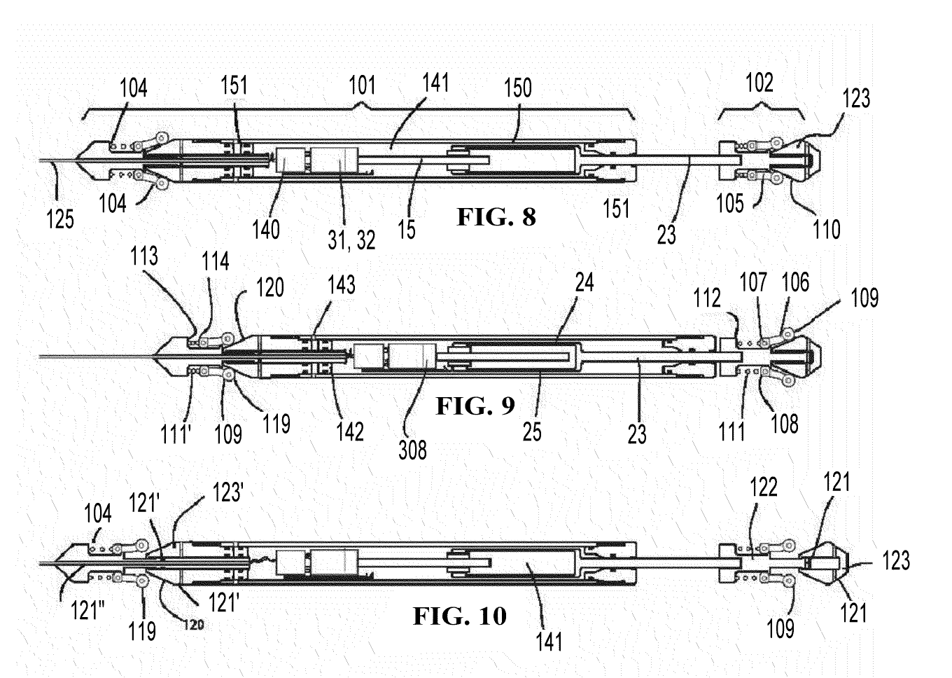

FIG. 8 is a section side view through a push me, pull me type traction unit using the actuator described here in to achieve the pushing and pulling.

FIG. 9 is a similar view to FIG. 8, the traction tool being is a second state.

FIG. 10 is a similar view to FIG. 8, the traction tool being is a third state.

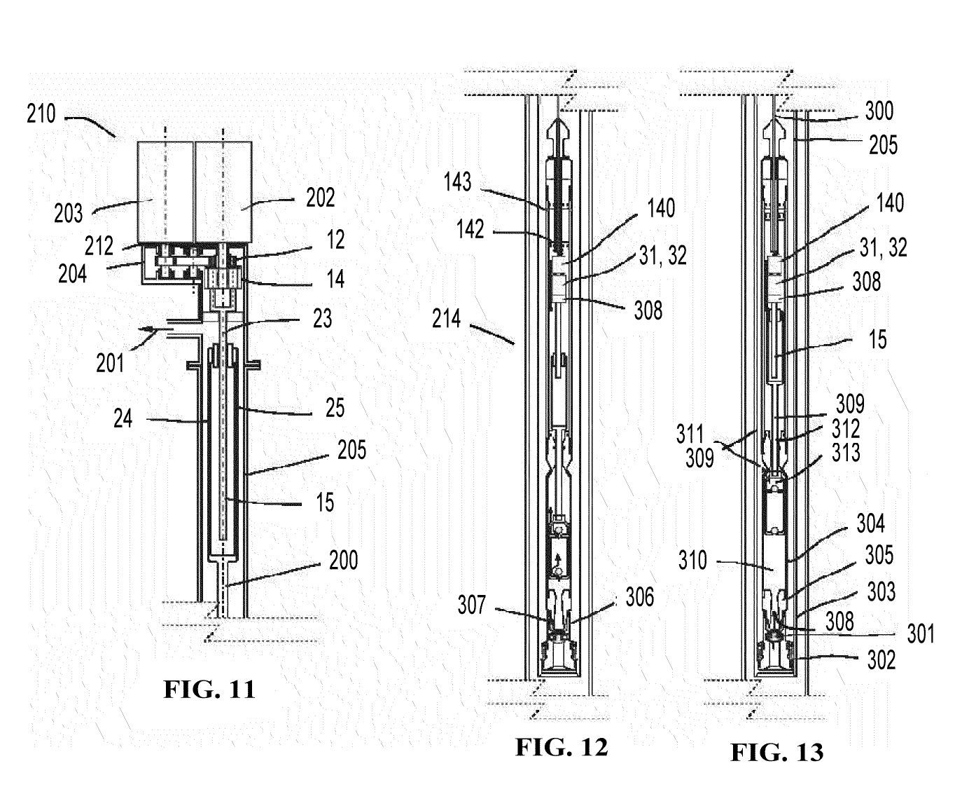

FIG. 11 shows the actuator mechanism fitted to a well at surface as an alternative to a conventional nodding donkey.

FIG. 12 is a section side view of the actuator in the lower part of a well powered by an umbilical and connected to a rod lift pump.

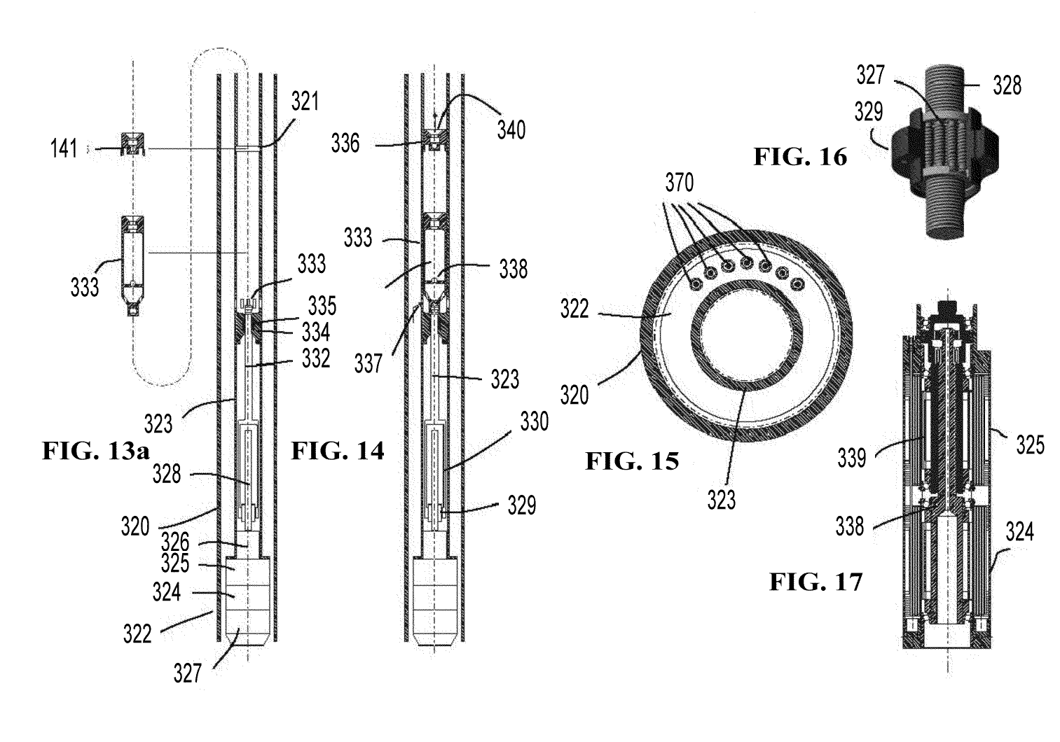

FIG. 13 is a similar view to FIG. 12, showing the actuator and lift pump at the opposite end of its cycle.

FIG. 13A is a section side view of another type of pump.

FIG. 14 is a section side view of an inverted rod lift pump.

FIG. 15 is a section top view of a power line configuration.

FIG. 16 is a perspective view of a nut coupled to a screw shaft.

FIG. 17 is a section side view of a lower end of a pump tool.

Referring to FIGS. 1 to 3 there is shown an epicyclical gear arrangement; a sun gear 1 is driven by an electric motor 2 in a clockwise direction. A ring gear 3 also turns in a counter clock wise direction, powered by a second electric motor 4 via an offset gear train 5 and lay shaft 6. The lay shaft 6 is supported by bearings 7 and 8.

One or more planet gears 55 (only one is here shown) are disposed between, and mesh with the sun gear 1 and ring gear 3. The planet gears are supported on a planet carrier 11 which turns a planetary output shaft 14. The epicyclical gearbox is supported by bearing 9 which engages the sun gear shaft 1′ rotates, and bearing 10, which engages the planetary output shaft 14.

For a particular diameter sun gear 1, planet gear 55 and ring gear 3 size (or tooth number), and for different rotational speeds of the sun and ring, a net resulting revolution speed (rpm) and direction of rotation (positive or clockwise (clock wise) or negative or counter clockwise (counter clock wise)) of the planet carrier 11 and planetary output shaft 14 will result. The relationship between the angular velocities of the ring gear ωᵣ, sun gear ωₛ and carrier ω_{c} may be expressed

R=(ωₛ−ω_{c})/(ωᵣ−ω_{c})

where R is a constant (the ratio of teeth on the ring gear and sun gear). Referring to the graph in FIG. 2, when the the outer ring 3 rotates counter clockwise at speeds from −500 to −6500 rpm (i.e. negative or counter clock wise) and similarly the sun 1 rotates at speeds in the example from +6500 to +500 rpm (positive=clock wise), if the ring gear 3 and sun gear 1 are ramped up and down in the fixed relationship indicated, the planet carrier 11 rotational direction can change from a negative or counter clockwise direction to a positive or clockwise very smoothly and under total control. The speed can be adjusted proportionally to a weighted average of the sun and ring gear 3. It will be appreciated that the motors are always running, this is very important for the longevity of the motors, because every time a motor is started it is subjected to a surge in voltage and current which has undesirable effects on the insulation.

It will be appreciated that if a reciprocating pump has 6 strokes/min the number of cycles per day is 8,460 per day and per year 3,153,600 per year. If a motor had to switch from clock wise to counter clock wise rotation that many times it would inevitably suffer a failure in its insulation.

It will also be appreciated that the motors can be synchronised to reach maximum speed and power without the planet carrier rotating. This would be advantageous to apply a strong force to open or close a sliding sleeve. Alternatively, a strong oscillating force could be generated to again work a device free, or achieve some other use.

Referring to FIGS. 4 and 5 there is shown the actuator 72 connected to a reciprocating pump 74. In this example the motor 28 and 29 are axially offset from each other. The motor 29 drives the annular ring of the gearbox 12 via a toothed belt 13. The planetary output shaft 14 is connected to a ball screw 15, so that the ball screw carrier 16 moves either up (i.e. towards the gearbox 12) or down (i.e. towards the reciprocating pump 74) the ball screw 15 depending upon the direction of rotation of the planet carrier.

The ball screw carrier 16 slidably engages with a shaft 19. As the ball screw carrier 16 moves up the screw 15, towards the upper region of its travel it reaches an upper end stop 18, which pushes shaft 19 upwards. Similarly, as the ball screw carrier 16 moves down the screw 15, towards its lower limit it reaches a lower end stop 17, causing the shaft 19 to move downwards. This reciprocating movement of the shaft 19 in turn causes a protrusion 20 to rock a switch 21 from position from a first position to a second position, and back again. This action either opens or closes a control circuit in the motor controller, the motor controller being pre-programmed to operate at one of two speeds corresponding to this switch signal. In this way, the actuator can control the alternating movement of the carrier shaft automatically.

Extension rods 24 and 25 fixedly extend from the ball screw carrier 16 spaced either side of and axially parallel to the ball screw 15. The extensions rods are connected to a rod 23 via a block 76. A piston pump, or rod lift pump 22 is connected to the lower end of the rod 23. The piston pump 22 is contained in a chamber 26.

As the ball screw carrier 16 is moved alternately up and down the ball screw 15, the piston pump 22 follows the reciprocating movement, removing fluid from the well with every upward stroke, and recharging the chamber 26 with every downward stroke, as is well known in the art.

Referring to FIGS. 6 and 7 there are shown two different types of concentric motor arrangements. It will be appreciated that in an oil well, the external diameter of anything to be run into the well is limited to the inner diameter that the well has been constructed with, which is usually relatively narrow.

To maximise the power of the electric motor it is necessary to make the motor with the largest diameter possible that could fit within the wells dimensions. The concentric arrangement enables the stator of both these motors to be relatively large.

Each concentric motor arrangement will now be described; first, referring to FIG. 6, two motors, a first motor 31, and a second motor 32 are concentrically mounted in a housing 30. The stators of each motor are identical, and consist of laminations 33 with motor windings 34, the power supply 35 for the first motor passes through a slot 36 in the bearing 37. The power supply 38 for the second motor passes through the same slot 36, then through passages in the laminations of the motor 31, through slot 39 in bearing 40, and a slot 41 in bearing 42.

The motors have been optimised to provide the maximum shaft diameter in the available space. The shaft 78 of the first motor running in bearing 37, 40 and 44, and the shaft 79 in the second motor running in bearings 42, 43 and 45. On each shaft are mounted magnets 46, in sets of north and south poles, typically to maximise the shaft diameter, the number of pole sets is increased.

The output from the shaft 79 of the second motor drives the ring gear 47 of the epicyclic gearbox. The output from the shaft 78 of the first motor is connected by a coupling member 48 to a shaft 49 which runs through the centre of the shaft 79 of the second motor. Shaft 49 is supported on bearings 50, 51 and 52, and this shaft couples to the sun gear 53 of the epicyclic gearbox. The first motor rotates 31 clock wise and the second motor rotates counter clock wise, and depending upon the speed of each motor, the planet carrier 54 will rotate clock wise or counter clock wise.

Referring to FIG. 7, the first motor 31 shown here employs a different motor type, typically known as an outside-in motor, where the stator 57 is located on the inside of the motor 31 and the rotor 58 in an annular housing around the outside of the stator 57.

A static central shaft 60 has laminations 61 fixed to it and motor windings 62 passing through and around them. Mounted on bearings 63, 64, 65, 66 and 67 is a tubular output shaft 68 for this motor 31.

Magnets 69 are located in the tube 68, adjacent to the laminations, in sets of north and south poles (i.e. oriented alternately so that the north or soft pole of each magnetic is facing radially outwards). The other end of the tube 68 is connected to the ring gear 70 of the epicyclic gearbox.

The second motor 31 in FIG. 7 is of conventional type, with a permanent magnet rotor shaft 58 centrally borne on bearings 80, 81. The shaft 58 drives the sun gear 82.

Referring to FIGS. 8 to 10, there is shown an upper part to a tool 101 and lower part 102 connected via an actuator rod 23.

The internal mechanism driving the actuator has already been generally described, with the either arrangement shown in FIGS. 6 and 7 being suitable to deliver the necessary reciprocating motion to shaft 23, though similarly the offset motors shown in FIGS. 4 and 5 could be adapted for use in the tool.

The upper part 101 and the lower parts 102 of the tool have simple anchor mechanisms 105 and 104 respectively. In FIG. 8, the lower anchor mechanism 104 is shown in retracted position and the upper anchor mechanism 105 in an active position. Referring particularly to the lower anchor in FIG. 9, each anchor consists of a set of arms 106, which at one end are pivotally constrained by pins 107 to an annular ring 108, the other end of the arms 106 having rollers 109 which rest on a conical surface 110 of part 123. A spring 111 reacts against the face 112, which tends to push the roller 109 along the conical surface 110, urging the rollers radially outwards. While there is a force in the actuator rod 23 urging the face 112 downwards, the rollers 106 in the lower part of the tool 102 will grip more firmly against the inner surface of the tubular member that the tool is installed in. At the same time, the rollers 109 on the upper part of the tool 101 are working in the converse manner, the rollers 119 on the upper anchor at this moment being pushed down the conical surface 120, compressing the spring 111′, and hence not gripping the inner surface of the pipe the tool is installed in, so that the upper part of the tool is pulled downwards (i.e. towards the right in the figures).

When the actuator rod is then extended, the operation of the anchor mechanisms are reversed, the upper part of the tool 101 by face 114 acting on spring 111′ to force rollers 109 up the conical face 120 to anchored the upper part of the tool 101 to the tubular member. Meanwhile, the anchor 105 on the lower part of the tool 102 the rollers 109 on it tend to be pushed down the conical surface 110, compressing the spring 111 and hence releasing the inner surface of the tubular the tool is installed, in allowing it to freely extend. This operation repeats itself, enabling the tool to walk itself into the well.

Referring to FIG. 10, shear pins 121, 121′ may be fitted into the each anchor assembly 104, 105, to allow the tool to be retrieved should it need to be returned to surface. When sheared, these pins 121, 121′ allow the two piece body 122 and 123 of anchor 104, the two piece body 122′ and 123′ of anchor 105 to separate a controlled distance, thereby disabling the rollers 109 and 119 from engaging their respective conical surfaces 110 and 120. The shear pins of the tool could be made from a material such as magnesium, so in the event that the tool is left in the well for a long period of time, the magnesium will degrade by being exposed to wellbore fluids, no over pull would be required as the anchors would have become deactivated.

The electric motors 31 and 32, are operated by a controller 140, electrical power being supplied via a slickline 125 such as described by U.S. Pat. No. 7,541,543. The entire internal workings are contained within a housing 150, the rotating shafts being supported dynamic seals 151, so that the motors and other components may be submerged in a motor oil 141. This motor oil is maintained at the same pressure as the external wellbore pressure by a pressure compensating piston 142, via port 143 in the tool's housing 150. Each time the actuator 23 moves out and in a volume of oil passes over the electric motors assisting in maintaining their temperature stable.

Referring to FIG. 11 there is shown an actuator mechanism 210 operating using the principals described, connected to a wellhead 212, fitted inside the well just below surface, removing it from external view. The actuator mechanism lifts and lowers sucker rods 200 situated inside the production tubing 205, so that resulting production from the well exits from passage 201. The only components visible at surface are the two electric motors 202 and 203 and the transmission housing 204.

Referring to FIGS. 12 and 13, there is shown an embodiment of this invention fitted at the lower end of a well. A tool 214 is conveyed into the well on an umbilical 300, inside the production tubing 205, the umbilical remains in the well and supplies the electrical power to operate the actuator mechanism. The lower most part of the tool includes a rod lift system, that is, a retrievable standing valve or non-return valve 301 located in a nipple profile 302 in the tail pipe 303. The rod lift barrel 304 has a lower housing 305 which strings into a receptacle bore 306 of the retrievable standing valve 301. A seal 307 isolates the pump inlet from the pump outlet. The actuator mechanism is as described in FIGS. 8 to 10, with the electric motors 31 and 32 driving through an epicyclic gearbox, which in turn drives a ball screw 15 which in turn is connected to the pulling rod 309. On the up stroke of the pulling rod, fluid is drawn through the standing valve 301 into the chamber 310, and then out into the production tubing 311, and on the down stroke, the upper and lower valves 312, 313 are lifted off their seats and the chambers above them are recharged.

Another type of pump is shown in FIG. 13A, where a pump tool 320 is deploying in a well casing 322, depending from a length of tubing 323.

Referring also to FIG. 17, at the lower end of the pump tool 320, a first motor 324, second motor 325 and gearbox 326 are located, the gearbox comprising epicyclical gears. Here the first motor is shown driving a shaft 338 that passes through the centre of the second motor to drive the sun gear, while the second motor drives a shaft 339 which drives the ring gear of the gearbox 326, in an arrangement similar to that shown in FIG. 6. However, the arrangement shown in FIG. 7, or any of the other variations described could equally be used. An oil compensation chamber 327 may be included to which equalises the oil pressure in the motor with the pressure in the well bore.

FIG. 15 shows a possible power line configuration, with seven similar conductors 340 disposed outside the tube 232, and entering the motor housing 322. Three of the conductors supply the first motor with three-phase supply, three of the conductors supply the second motor with three phase supply, while the final conductor powers and transmits signals to and from a position sensor.

A screw shaft 328 extends from the planet carrier. Referring also to FIG. 16, a nut 329 is coupled to the screw shaft 328 by a set of rollers 327 to provide a roller screw, which operates in a similar manner to the ball screw previously described.

The nut 329 is coupled via arms 330 to an actuator rod 332 that extends upwards along the centre axis of the tube. As with previous examples, the motors and gearbox 324, 325, 326 can be driven to provide a smoothly alternating rotation, that is converted into a reciprocal movement by the roller screw, so that the actuator rod can be driven in a reciprocal movement upwards and downwards. The actuator rod 332 is supported by a centraliser 334 having dynamic seals 335, which is located so that the upper end of the actuator rod 332 extends through the centraliser 334 when the actuator rod is at the bottom of its stroke. The actuator rod terminates in a profiled end 333. The tubing has an inlet port 337 just above the centraliser 334.

Referring to FIG. 14, an inverted rod lift pump 333, and a check valve 336, may be deployed down the tubing. The pump 333 engages with the profiled end 333 of the actuator rod. The check valve 336 engages includes a resilient profile on its outer diameter, that engages with a groove on the inner diameter of the tube located above the tool 320.

As the actuator rod 332 rises, it pushes the pump 333 upwards, and fluid in and above the pump is also pushed upwards, the ball valve 338 in the pump 333 being forced shut, and the ball valve 340 in the check valve 336 opening. On the down stroke of the actuator rod 332, the ball valve 338 in the pump 333 opens to allow more fluid into the pump, and the ball valve 340 in the check valve 336 prevents fluid above the check valve from returning. This process is repeated to force fluid from the well up tube 323 to the surface. The downhole assembly could include a control system to control the motors, this would be located at 327, this would reduce the number of cables required from surface from 7 to 2, in addition DC voltage could be supplied which would make the cable very compact and cost effective.

The inverted rod lift pump 333 and the check valve 336 may both be retrieved, for example by using a fishing profile on a wireline.

1. A motor transmission and gearbox for downhole use, comprising:
a first motor driving a first input shaft;
a second motor driving a second input shaft;
a gearbox comprising at least
a ring gear,
a sun gear, and
a planetary gear and planetary carrier;
the first input shaft driving either the ring gear, the sun gear or the planetary gear and/or planetary carrier;
the second input shaft driving one of the gears not driven by the first input shaft; and
the remaining gear driving the output shaft.

2. A motor transmission and gearbox according to claim 1, wherein the first input shaft drives the ring gear, the second input shaft drives the sun gear, and the planetary gear and carrier drives the output shaft.

3. A motor transmission and gearbox according to claim 1, wherein the first motor and second motors rotate in opposite angular directions.

4. A motor transmission and gearbox according to claim 1, wherein an increase of speed of the first motor results in a decrease of speed of the second motor.

5. A motor transmission and gearbox according to claim 1, wherein the first motor and second motors are operated to cause the output shaft to be driven in a first direction and then a second direction in an alternating manner.

6. A motor transmission and gearbox according to claim 5, wherein motion of the output shaft is converted to reciprocating linear motion.

7. A motor transmission and gearbox according to claim 6, wherein the reciprocating output is used to drive a pump.

8. A motor transmission and gearbox according to claim 7, wherein the pump is a rod or linear pump.

9. A motor transmission and gearbox according to claim 6, wherein the reciprocating motion is used to drive a tractor tool comprising alternately engaging anchors, the distance between the anchors alternately extending and contracting.

10. A motor transmission and gearbox according to any of claim 1, wherein the both input shafts are rotating, in order that the output drive is near zero, and small variations in the input shafts' relative rotation are used to impart a jarring motion to the output shaft.

11. A motor transmission and gearbox according to claim 1, wherein the motor inputs are concentric.

12. A motor transmission and gearbox according to claim 11 wherein the gearbox output is concentric with the motor outputs.

13. A system including a motor transmission and gearbox according to claim 1, wherein that can be deployed on wireline into a well without a rig.

14. A system including a motor transmission and gearbox according to claim 1, wherein the system is deployed on tubing into a well, and the pump parts are retrieved through the tubing.

15. A system including a motor transmission and gearbox according to claim 1, wherein that can be deployed into a well and landed into a electrical wet connector and powered thru the electrical wet connector.

16. A system including a motor transmission and gearbox according to claim 1, wherein a control system is deployed with the motors to control the motor locally.

17. A system including a motor transmission and gearbox according to claim 1, wherein DC power is supplied to the downhole control system.
